(19) United States
(12) Patent Application Publication
(10) Pub. No.: US 2026/0188876 A1
(43) Pub. Date: Jul. 2, 2026

(54) CASE FOR SECONDARY BATTERY, SECONDARY BATTERY INCLUDING CASE, AND METHOD OF MANUFACTURING SECONDARY BATTERY

(71) Applicant: SAMSUNG SDI CO., LTD., Yongin-si (KR)

(72) Inventor: Sungmin CHO, Yongin-si (KR)

(21) Appl. No.: 19/408,655

(22) Filed: Dec. 4, 2025

(30) Foreign Application Priority Data
Jan. 2, 2025 (KR) 10-2025-0000333

(51) Int. Cl. H01M 50/581; H01M 50/107; H01M 50/152; H01M 50/167; H01M 50/186; H01M 50/586

(52) U.S. Cl. CPC H01M 50/581; H01M 50/107; H01M 50/152; H01M 50/167; H01M 50/186; H01M 50/586

(57) ABSTRACT

A case for a secondary battery may include a bottom part and a sidewall part connected to the bottom part, the bottom part and the sidewall part defining an opening opposite to the bottom part, wherein the sidewall part may include a first cylindrical portion extending from the bottom part and a second cylindrical portion extending from the first cylindrical portion toward the opening, wherein a thickness of the first cylindrical portion and a thickness of the second cylindrical portion may be different, and wherein an elastic member may be disposed on at least a portion of an inner circumferential surface of the second cylindrical portion.

### CROSS-REFERENCE TO RELATED APPLICATION

The present application claims priority to and the benefit of Korean Application No. 10-2025-0000333, filed on Jan. 2, 2025, in the Korean Intellectual Property Office, the entire disclosure of which is incorporated by reference herein.

### BACKGROUND

### Field

The present disclosure relates to a case for a secondary battery, a secondary battery including the case, and a method of manufacturing the secondary battery.

### Description of the Related Art

While primary batteries are not designed to be (re)charged, secondary (also known as rechargeable) batteries are batteries that are designed to be discharged and recharged. Among secondary batteries, low-capacity secondary batteries are widely used in portable, small electronic devices, such as smart phones, feature phones, notebook computers, digital cameras, and camcorders, while high-capacity secondary batteries are widely used as power sources for driving motors in hybrid vehicles and electric vehicles, as well as for storing power (e.g., home and/or utility scale power storage). A secondary battery generally includes an electrode assembly including a positive electrode and a negative electrode, a case accommodating both electrodes, and electrode terminals connected to the electrode assembly.

Depending on the geometry of the battery case, secondary batteries are classified into coin-type batteries, cylindrical batteries, prismatic batteries, and pouch-type batteries. The electrode assembly mounted within the battery case is a chargeable and dischargeable power generating element typically having a stacked structure including a positive electrode, a separator, and a negative electrode. The electrode assembly may have a jelly-roll type configuration having a separator interposed between sheets of positive and negative electrodes coated with active material, where the resulting laminate is wound. A plurality of positive electrodes and negative electrodes are sequentially stacked with separators interposed therebetween, and wound together with a long separator film.

The jelly-roll type electrode assembly is widely used because manufacturing is relatively convenient and the energy density per weight is relatively high. A cylindrical secondary battery is manufactured by inserting the jelly-roll type electrode assembly into a cylindrical can then covering the can with a cap assembly that serves as a lid.

Conventionally, during insertion of the jelly-roll type electrode assembly into the can, collision between the electrode assembly and the case may occur, thereby causing damage to the electrode assembly resulting in short circuiting. When a short circuit occurs and the internal temperature of the secondary battery rises, a chain explosion to adjacent battery units may occur if gas or flame generated by the short circuit cannot be discharged through the cap assembly positioned at the top of the case.

This Background section is for the general understanding of the background of the present disclosure, and therefore, it may contain information that does not constitute related (or prior) art.

### SUMMARY

These and other aspects and features of the present disclosure will be described in or will be apparent from the following description of embodiments of the present disclosure.

According to an embodiment of the present disclosure, a case for a secondary battery includes a bottom part, a sidewall part connected to the bottom part, and an opening opposite to the bottom part, wherein the sidewall part includes a first cylindrical portion extending from the bottom part and a second cylindrical portion extending from the first cylindrical portion toward the opening, wherein a thickness of the first cylindrical portion and a thickness of the second cylindrical portion are different from each other, and wherein an elastic member is disposed on at least a portion of an inner circumferential surface of the second cylindrical portion.

Embodiments of the present disclosure provide a case including a bottom part and a sidewall part connected to the bottom part, the bottom part and the sidewall part defining an opening opposite to the bottom part, wherein the sidewall part includes a first cylindrical portion extending from the bottom part and a second cylindrical portion extending from the first cylindrical portion toward the opening, wherein a thickness of the first cylindrical portion and a thickness of the second cylindrical portion is different, and wherein an elastic member is disposed on at least a portion of an inner circumferential surface of the second cylindrical portion.

In some embodiments, the thickness of the first cylindrical portion may correspond to a thickness obtained by adding a thickness of the elastic member to the thickness of the second cylindrical portion.

In some embodiments, the thickness of the first cylindrical portion is substantially equal to a sum of a thickness of the elastic member and the thickness of the second cylindrical portion.

In some embodiments, the thickness of the second cylindrical portion may correspond to the thickness of the elastic member.

In some embodiments, the thickness of the second cylindrical portion is substantially equal to the thickness of the elastic member.

In some embodiments, the elastic member may extend along the inner circumferential surface of the second cylindrical portion from one end of the second cylindrical portion.

In some embodiments, the elastic member extends along the inner circumferential surface from one end of the second cylindrical portion.

In some embodiments, the case may further include a stepped portion protruding from an inner circumferential surface of the first cylindrical portion.

In some embodiments, the sidewall part may include a beading portion formed by bending the second cylindrical portion.

In some embodiments, the second cylindrical portion is bent inward forming a beading portion.

In some embodiments, the sidewall part may include a crimping portion formed by bending one end of the second cylindrical portion, the crimping portion being connected to the beading portion.

In some embodiments, one end of the second cylindrical portion is bent inward forming a crimping portion.

In some embodiments, the elastic member may melt when a temperature inside the case is greater than or equal to a predetermined temperature.

In some embodiments, the elastic member is configured to melt upon a temperature inside the case being equal to or greater than a predetermined temperature.

According to an embodiment of the present disclosure, a secondary battery includes an electrode assembly, a case including a bottom part, a sidewall part connected to the bottom part, and an opening opposite to the bottom part, the case accommodating the electrode assembly, and a cap assembly coupled to one end of the sidewall part of the case to seal the opening, wherein the sidewall part includes a first cylindrical portion extending from the bottom part and a second cylindrical portion extending from the first cylindrical portion toward the opening, wherein a thickness of the first cylindrical portion and a thickness of the second cylindrical portion are different from each other, and wherein an elastic member is disposed on at least a portion of an inner circumferential surface of the second cylindrical portion.

Embodiments of the present disclosure provide a secondary battery including: an electrode assembly; a case comprising a bottom part and a sidewall part connected to the bottom part, the bottom part and the sidewall part defining an opening opposite to the bottom part, the case accommodating the electrode assembly; and a cap assembly coupled to one end of the sidewall part, the cap assembly configured to seal the opening, wherein the sidewall part includes a first cylindrical portion extending from the bottom part and a second cylindrical portion extending from the first cylindrical portion toward the opening, wherein a thickness of the first cylindrical portion and a thickness of the second cylindrical portion is different, and wherein an elastic member is disposed on at least a portion of an inner circumferential surface of the second cylindrical portion.

In some embodiments, the thickness of the first cylindrical portion may correspond to a thickness obtained by adding a thickness of the elastic member to the thickness of the second cylindrical portion.

In some embodiments, the thickness of the first cylindrical portion is substantially equal to a sum of a thickness of the elastic member and the thickness of the second cylindrical portion.

In some embodiments, the thickness of the second cylindrical portion may correspond to the thickness of the elastic member.

In some embodiments, the thickness of the second cylindrical portion is substantially equal to the thickness of the elastic member.

In some embodiments, the elastic member may extend along the inner circumferential surface of the second cylindrical portion from one end of the second cylindrical portion.

In some embodiments, the elastic member extends along the inner circumferential surface from one end of the second cylindrical portion.

In some embodiments, the secondary battery may further include a stepped portion protruding from an inner circumferential surface of the first cylindrical portion.

In some embodiments, the case further includes a stepped portion protruding from an inner circumferential surface of the first cylindrical portion.

In some embodiments, the sidewall part may include a beading portion formed by bending the second cylindrical portion.

In some embodiments, the second cylindrical portion is bent inward forming a beading portion.

In some embodiments, the sidewall part may include a crimping portion formed by bending one end of the second cylindrical portion, the crimping portion being connected to the beading portion.

In some embodiments, one end of the second cylindrical portion is bent inward forming a crimping portion.

In some embodiments, the elastic member may melt when a temperature inside the case is greater than or equal to a predetermined temperature.

In some embodiments, the elastic member is configured to melt upon a temperature inside the case being equal to or greater than a predetermined temperature.

According to an embodiment of the present disclosure, a method of manufacturing a secondary battery includes preparing a case that includes a bottom part, a sidewall part connected to the bottom part, and an opening opposite to the bottom part, inserting an electrode assembly into the case, bending the sidewall part to form a beading portion, mounting a cap assembly inside the beading portion, and bending one end of the sidewall part to form a crimping portion, thereby sealing the opening with the cap assembly, wherein the sidewall part includes a first cylindrical portion extending from the bottom part and a second cylindrical portion extending from the first cylindrical portion toward the opening, wherein a thickness of the first cylindrical portion and a thickness of the second cylindrical portion are different from each other, and wherein an elastic member is disposed on at least a portion of an inner circumferential surface of the second cylindrical portion.

Embodiments of the present disclosure provide a method of manufacturing a secondary battery including: preparing a case comprising a bottom part and a sidewall part connected to the bottom part, the bottom part and the sidewall part defining an opening opposite to the bottom part; inserting an electrode assembly into the case; forming a beading portion by bending the sidewall part; mounting a cap assembly inside the beading portion; and forming a crimping portion by bending one end of the sidewall part, thereby sealing the opening with the cap assembly, wherein the sidewall part includes a first cylindrical portion extending from the bottom part and a second cylindrical portion extending from the first cylindrical portion toward the opening, wherein a thickness of the first cylindrical portion and a thickness of the second cylindrical portion are different, and wherein an elastic member is disposed on at least a portion of an inner circumferential surface of the second cylindrical portion.

In some embodiments, the forming the beading portion may include bending the second cylindrical portion on which the elastic member is disposed.

In some embodiments, sealing the opening may include bending one end of the second cylindrical portion on which the elastic member is disposed.

In some embodiments, the forming the crimping portion comprises bending one end of the second cylindrical portion on which the elastic member is disposed.

In some embodiments, the thickness of the first cylindrical portion may correspond to a thickness obtained by adding a thickness of the elastic member to the thickness of the second cylindrical portion, and wherein the thickness of the second cylindrical portion corresponds to the thickness of the elastic member.

In some embodiments, the thickness of the first cylindrical portion is substantially equal to a sum of a thickness of the elastic member and the thickness of the second cylindrical portion.

According to various embodiments of the present disclosure, because the elastic member is disposed on an inner circumferential surface of the case that accommodates the electrode assembly of the secondary battery, a collision between the electrode assembly and the case that may occur during a manufacturing process of the secondary battery may be mitigated.

According to various embodiments of the present disclosure, when a short circuit occurs in the secondary battery and the temperature inside the case rises, the elastic member disposed on the inner circumferential surface of the case may melt, whereby the cap assembly may be easily detached from the case. With this structure, flame or gas generated by the short circuit may be discharged through an opening formed at an upper portion of the case by detachment of the cap assembly, thereby preventing a chain explosion of adjacent batteries.

### BRIEF DESCRIPTION OF THE DRAWINGS

The drawings illustrate embodiments of the present disclosure, and further describe aspects and features of the present disclosure along with the detailed description of the present disclosure. Thus, the present disclosure should not be construed as being limited to the drawings.

FIG. 1 is a perspective view illustrating a secondary battery according to embodiments of the present disclosure.

FIG. 2 is a longitudinal cross-sectional view illustrating a secondary battery according to embodiments of the present disclosure.

FIGS. 3A and 3B show geometries of a case according to embodiments of the present disclosure.

FIG. 4 is a cross-sectional view taken along line A-A′ of the sidewall part of the case according to FIG. 3 according to embodiments of the present disclosure.

FIG. 5 is an enlarged longitudinal cross-sectional view showing a portion of the sidewall part of the case according to embodiments of the present disclosure.

FIG. 6 shows a collision between the electrode assembly and the case being mitigated according to embodiments of the present disclosure.

FIG. 7 shows the cap assembly being detached from the case according to embodiments of the present disclosure.

FIG. 8 is a cross-sectional view of a case including a stepped portion according to embodiments of the present disclosure.

FIG. 9 is a flowchart of a method of manufacturing a secondary battery according to embodiments of the present disclosure.

FIG. 10 shows the method of manufacturing a secondary battery according to embodiments of the present disclosure.

FIG. 11 shows the method of manufacturing a secondary battery according to embodiments of the present disclosure.

FIG. 12 shows the method of manufacturing a secondary battery according to embodiments of the present disclosure.

### DETAILED DESCRIPTION

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her invention in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being \“coupled\” or \“connected\” to a second element, the first element may be directly coupled or connected to the second element or the first element may be indirectly coupled or connected to the second element via one or more intervening elements.

To facilitate understanding of the disclosure, the attached drawings are not drawn to actual scale and the dimensions of some components may be exaggerated. Furthermore, the same reference numbers may be assigned to the same components in different embodiments. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked,” or “connected” to each other, or another component may be “interposed” between the components.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

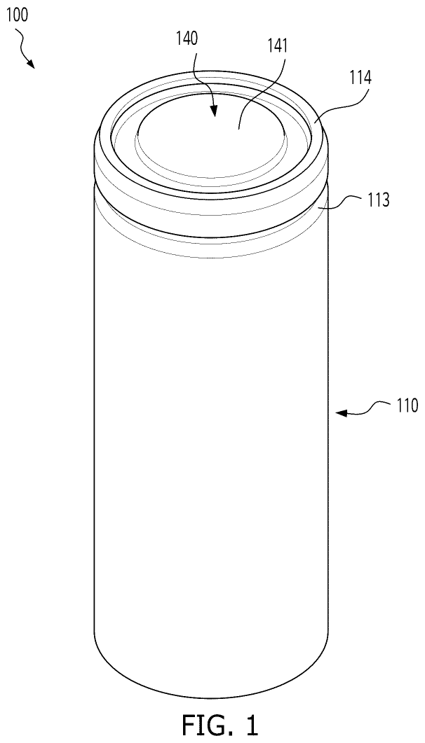

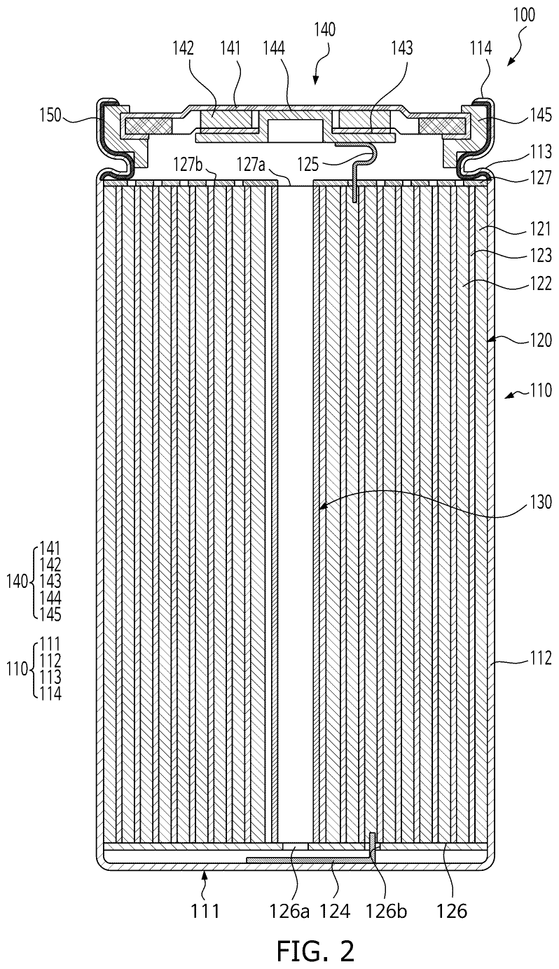

FIG. 1 is a perspective view illustrating a secondary battery. FIG. 2 is a cross-sectional view illustrating a secondary battery.

As shown in FIGS. 1 and 2, a cylindrical lithium-ion secondary battery 100 may include a case 110, an electrode assembly 120, and a cap assembly 140. The cylindrical lithium-ion secondary battery 100 may include a center pin 130. The cap assembly 140 may perform a current interruption operation and is referred to as a current interrupt device (CID).

The case 110 may have a substantially circular bottom part 111 and a cylindrical sidewall 112 upwardly extending (e.g., extending at a predetermined length) from a circumference of the bottom part 111. During the manufacturing of the secondary battery 100, the top portion of the case 110 is open. The electrode assembly 120 and the center pin 130 may be inserted into the case 110 together with an electrolyte. The case 110 may include steel, stainless steel, aluminum, aluminum alloy, or an equivalent thereof but is not limited thereto.

In some embodiments, to prevent the cap assembly 140 from being separated from the case 110, the case 110 may include a beading part 113 (e.g., a bead) recessed toward the center axis at the bottom of the cap assembly 140 and a crimping part 114 (e.g., a crimp) bent towards the center axis at the top.

The electrode assembly 120 may be accommodated inside the case 110. The electrode assembly 120 may include a negative electrode plate 121 coated with a negative electrode active material (e.g., graphite, carbon, etc.) on a negative electrode current collector plate, a positive electrode plate 122 coated with a positive electrode active material (e.g., a transition metal oxide, such as LiCoO₂, LiNiO₂, LiMn₂O₄, etc.) on a positive electrode current collector plate, and a separator 123 positioned between the negative electrode plate 121 and the positive electrode plate 122 to prevent a short circuit therebetween while allowing the movement of lithium ions therethrough. In some embodiments, the negative electrode plate 121, the positive electrode plate 122, and the separator 123 may be wound in a substantially cylindrical shape. In an embodiment, the negative electrode current collector may include copper (Cu) foil, the positive electrode current collector may include aluminum (Al) foil, and the separator may include polyethylene (PE) or polypropylene (PP), but the present disclosure is not limited thereto.

In some embodiments, a negative electrode tab 124 protruding and extending a certain length downwardly from the electrode assembly 120 may be welded to the negative electrode plate 121, and a positive electrode tab 125 protruding and extending a certain length upwardly from the electrode assembly 120 may be welded to the positive electrode plate 122, but an opposite configuration is possible. For example, the negative electrode tab 124 may include copper or nickel, and the positive electrode tab 125 may include aluminum, but the present disclosure is not limited thereto.

In some embodiments, the negative electrode tab 124 of the electrode assembly 120 may be welded to the bottom part 111 of the case 110, and the case 110 may act as a negative electrode. In some embodiments, the positive electrode tab 125 may be welded to the bottom part 111 of the case 110, and the case 110 may act as a positive electrode.

In some embodiments, the secondary battery 100 may include a first insulation plate 126 coupled to the case 110, may have a first hole 126a at the center and one or more second holes 126b outside thereof, and may be interposed between the electrode assembly 120 and the bottom part 111. The first insulation plate 126 prevents the electrode assembly 120 from electrically contacting the bottom part 111 of the case 110. For example, the first insulation plate 126 prevents the positive electrode plate 122 of the electrode assembly 120 from electrically contacting the bottom part 111. The first hole 126a allows gas to quickly move upwardly through the center pin 130 if a large amount of gas is generated due to an abnormality of the secondary battery 100, and the one or more second holes 126b allow the negative electrode tab 124 to penetrate therethrough and be welded to the bottom part 111.

In some embodiments, the secondary battery 100 may include a second insulation plate 127 coupled to the case 110, having a first hole 127a at the center and a plurality of second holes 127b formed outside thereof, and may be interposed between the electrode assembly 120 and the cap assembly 140. The second insulation plate 127 prevents the electrode assembly 120 from electrically contacting the cap assembly 140. For example, the second insulation plate 127 prevents the negative electrode plate 121 of the electrode assembly 120 from electrically contacting the cap assembly 140. The first hole 127a allows gas to quickly move toward the cap assembly 140 if a large amount of gas is generated due to an abnormality of the secondary battery, and the second holes 127b allow the positive electrode tab 125 to penetrate therethrough and be welded to the cap assembly 140. In some embodiments, the remaining second holes 127b allow an electrolyte to quickly flow into the electrode assembly 120 in an electrolyte injection process.

In some embodiments, the diameters of the first holes 126a and 127a of the first and second insulation plates 126 and 127 are formed to have a diameter less than the diameter of the center pin 130, thereby preventing the center pin 130 from electrically contacting the bottom part 111 of the case 110 or the cap assembly 140 due to an external impact.

The center pin 130 has a geometry of a hollow circular pipe and may be coupled to the center of the electrode assembly 120. The center pin 130 may include steel, stainless steel, aluminum, an aluminum alloy, or polybutylene terephthalate, but the present disclosure is not limited thereto. The center pin 130 suppresses deformation of the electrode assembly 120 during charging and discharging of the battery and acts as a passage for gas generated inside the secondary battery. In some embodiments, the center pin 130 may be omitted.

The cap assembly 140 may include a top plate 141, a middle plate 142, an insulation plate 143, and a bottom plate 144.

The middle plate 142 is located below the top plate 141 and may have a substantially flat shape.

When viewed from the bottom, the insulation plate 143 may be formed in a circular ring geometry having a suitable width (e.g., a predetermined width). In some embodiments, the insulation plate 143 insulates the middle plate 142 and the bottom plate 144 from each other. The insulation plate 143 may be interposed between the middle plate 142 and the bottom plate 144 to then be ultrasonically welded, but the present disclosure is not limited thereto.

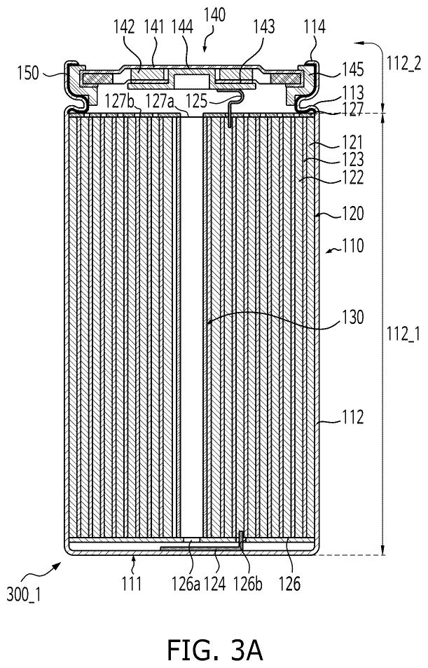

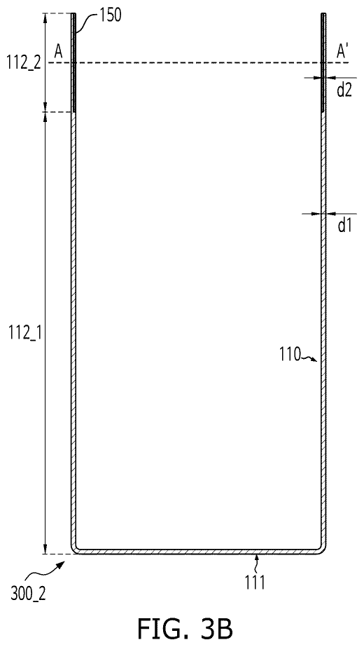

In some embodiment, the secondary battery 100 may further include an elastic member 150 disposed on at least a portion of an inner circumferential surface of the case 110. The structure and position of the elastic member 150 is described in detail with reference to FIGS. 3 to 5.

The present disclosure is not limited to a cylindrical lithium-ion secondary battery 100. For example, as long as the secondary battery 100 includes the electrode assembly 120, which is formed by winding the positive electrode plate 122, the negative electrode plate 121, and the separator 123, and the case 110 that accommodates the electrode assembly 120, various embodiments may be applied to secondary batteries of various types or shapes.

FIGS. 3A and 3B show geometries of a case. Referring to FIG. 3A, a first example 300_1 is a longitudinal cross-sectional view illustrating a secondary battery. Referring to FIG. 3B, a second example 300_2 is a longitudinal cross-sectional view illustrating the case 110 of the secondary battery.

Referring to the first example 300_1, the case 110 may include the bottom part 111, the sidewall part 112 connected to the bottom part 111, and an upper opening opposite to the bottom part 111. The case 110 may include a crimping portion 114 formed by bending one end of the sidewall part 112 and a beading portion 113 formed by bending the sidewall part 112 inwardly below the crimping portion 114. The electrode assembly 120 is inserted into the case 110 and may be positioned below the beading portion 113.

In some embodiments, the sidewall part 112 may include a first cylindrical portion 112_1 and a second cylindrical portion 112_2. The first cylindrical portion 112_1 may extend from the bottom part 111, and the second cylindrical portion 112_2 may extend from the first cylindrical portion 112_1 toward the opening of the case 110.

In some embodiments, the sidewall part 112 may include the beading portion 113, and the beading portion 113 may be formed by bending the second cylindrical portion 112_2. The beading portion 113 may be formed by bending the second cylindrical portion 112_2, which is located above the electrode assembly 120 inserted into the case 110. In some embodiments, the sidewall part 112 may include the crimping portion 114, and the crimping portion 114 may be formed by bending one end of the second cylindrical portion 112_2. The crimping portion 114 may be formed by bending one end of the second cylindrical portion 112_2 above the cap assembly 140. Although FIG. 3A illustrates the electrode assembly 120 as being accommodated in the first cylindrical portion 112_1, the present disclosure is not limited thereto. For example, the electrode assembly 120 may be accommodated in both the first cylindrical portion 112_1 and the second cylindrical portion 112_2 of the case 110.

The second example 300_2 may illustrate the case 110 in a state before the second cylindrical portion 112_2 of the sidewall part 112 is bent to form the beading portion 113 and the crimping portion 114. The second example 300_2 may illustrate a height-wise correspondence relationship with the case 110 shown in the first example 300_1. Sizes, thicknesses, and shapes of the illustrated regions (e.g., the first cylindrical portion 112_1 and the second cylindrical portion 112_2) may be exaggerated for clarity of description and are not limited to the illustrated shapes.

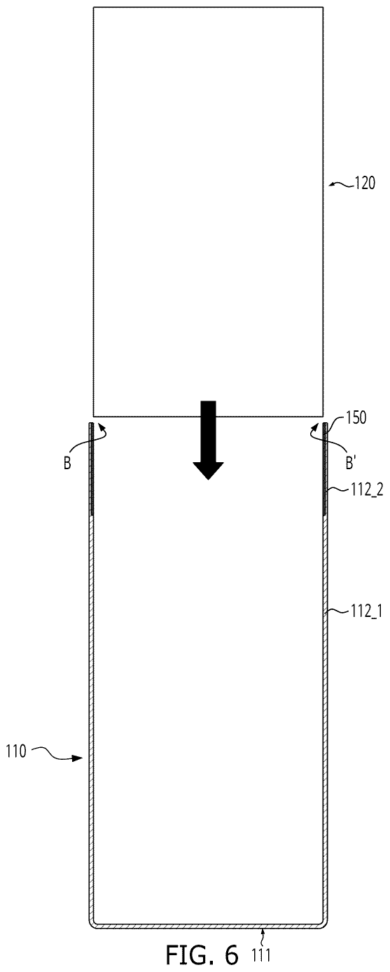

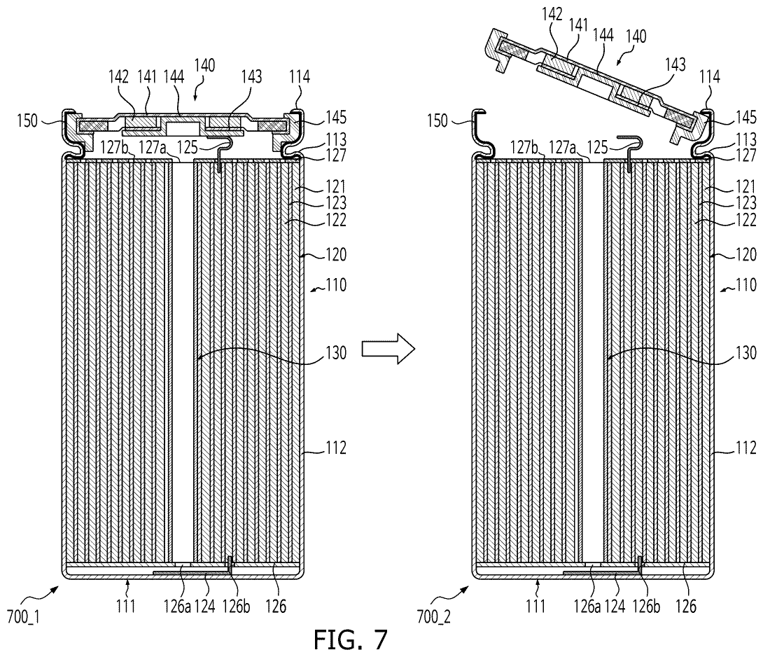

Referring to the second example 300_2, the elastic member 150 may be disposed on the second cylindrical portion 112_2. The elastic member 150 may be disposed on at least a portion of the inner circumferential surface of the second cylindrical portion 112_2. The elastic member 150 may extend along the inner circumferential surface of the second cylindrical portion 112_2 from one end of the second cylindrical portion 112_2. Accordingly, a collision between the electrode assembly 120 and the case 110, that may occur while the electrode assembly 120 is inserted into the case 110 during manufacturing of the secondary battery, may be mitigated. In some embodiments, the elastic member 150 may melt when a temperature inside the case 110 is equal to or greater than a predetermined temperature. For example, when a short circuit occurs between a first electrode and a second electrode of the electrode assembly 120 accommodated in the case 110 and the temperature inside the case 110 rises to be equal to or greater than a predetermined temperature, the elastic member 150 may melt. Accordingly, the cap assembly 140 may be easily detached from the case 110. Effects resulting from disposition of the elastic member 150 on the inner circumferential surface of the second cylindrical portion 112_2 is described in detail with reference to FIGS. 6 and 7.

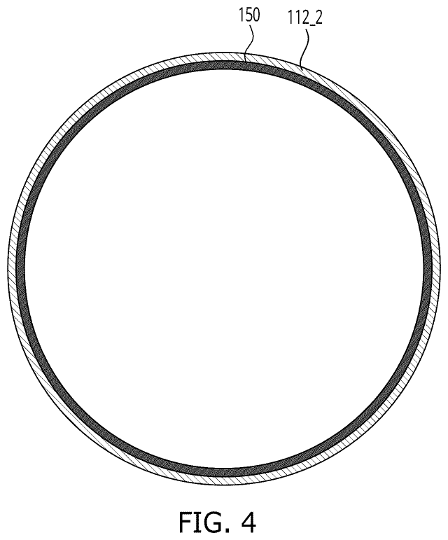

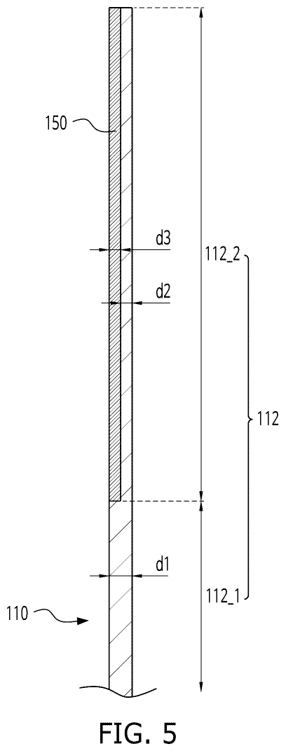

Referring to the second example 300_2, the sidewall part 112 may have different thicknesses at respective height regions. For example, a thickness d1 of the first cylindrical portion 112_1 and a thickness d2 of the second cylindrical portion 112_2 may be different from each other. An outer diameter of the sidewall part 112 may be constant regardless of the height region. Accordingly, inner diameters of the sidewall part 112 may be different in the respective regions of the first cylindrical portion 112_1 and the second cylindrical portion 112_2. Geometries of the first cylindrical portion 112_1 and the second cylindrical portion 112_2 is described in detail with reference to FIGS. 4 and 5.

FIG. 4 is a cross-sectional view of the sidewall part of the case according to FIG. 3, taken along line A-A′, and FIG. 5 is an enlarged longitudinal cross-sectional view showing a portion of the sidewall part of the case.

Referring to FIGS. 4 and 5, the sidewall part 112 of the case 110 may include the first cylindrical portion 112_1 and the second cylindrical portion 112_2 extending from the first cylindrical portion 112_1 toward the opening of the case 110. The elastic member 150 may be disposed on at least a portion of the inner circumferential surface of the second cylindrical portion 112_2. For example, the elastic member 150 may extend along the inner circumferential surface of the second cylindrical portion 112_2 from one end of the second cylindrical portion 112_2.

In some embodiments, the thickness d1 of the first cylindrical portion 112_1 and the thickness d2 of the second cylindrical portion 112_2 may be different from each other. For example, the thickness d1 of the first cylindrical portion 112_1 may correspond to a thickness obtained by adding a thickness d3 of the elastic member 150 to the thickness d2 of the second cylindrical portion 112_2. In some embodiments, the thickness d2 of the second cylindrical portion 112_2 may correspond to the thickness d3 of the elastic member 150. An outer diameter of each of the first cylindrical portion 112_1 and the second cylindrical portion 112_2 may be substantially constant, and inner diameters thereof may be different.

Geometries of the first cylindrical portion 112_1 and the second cylindrical portion 112_2 are not limited to those illustrated in FIGS. 4 and 5. For example, the thicknesses and lengths of the first cylindrical portion 112_1 and the second cylindrical portion 112_2 may be appropriately changed within a range in which rigidity of the sidewall part 112 of the case 110 can be secured.

FIG. 6 shows a collision between the electrode assembly and the case being mitigated. The sidewall part 112 of the case 110 illustrated in FIG. 6 may represent the case 110 in a state before the second cylindrical portion 112_2 is bent to form the beading portion and the crimping portion.

Referring to FIG. 6, the case 110 may include the bottom part 111, the sidewall part 112 connected to the bottom part 111, and an upper opening opposite to the bottom part 111. In some embodiments, the sidewall part 112 may include the first cylindrical portion 112_1 and the second cylindrical portion 112_2. The first cylindrical portion 112_1 may extend from the bottom part 111, and the second cylindrical portion 112_2 may extend from the first cylindrical portion 112_1 toward the opening of the case 110. In some embodiments, the elastic member 150 may be disposed on the second cylindrical portion 112_2. The elastic member 150 may be disposed on at least a portion of the inner circumferential surface of the second cylindrical portion 112_2. The elastic member 150 may extend along the inner circumferential surface of the second cylindrical portion 112_2 from one end of the second cylindrical portion 112_2.

In this manner, a collision between the electrode assembly 120 and the case 110, that may occur while the electrode assembly 120 is inserted into the case 110 during a manufacturing process of the secondary battery, may be mitigated. For example, when a central axis of the electrode assembly 120 and a central axis of the case 110 are not aligned while the electrode assembly 120 is inserted into the case 110, an impact generated at a contact portion B or B′ where the electrode assembly 120 collides with one end of the second cylindrical portion 112_2 may be mitigated.

Configurations illustrated in FIG. 6 are simplified only for convenience of understanding, and specific structures of the illustrated regions are not limited thereto.

FIG. 7 shows the cap assembly being detached from the case.

In some embodiments, the secondary battery may include the electrode assembly 120; a case 110 including the bottom part 111, the sidewall part 112 connected to the bottom part 111, and an opening opposite to the bottom part 111 and accommodating the electrode assembly 120; and a cap assembly 140 coupled to one end of the sidewall part 112 of the case 110 to seal the opening. Here, the sidewall part 112 may include the first cylindrical portion 112_1 extending from the bottom part 111 and the second cylindrical portion 112_2 extending from the first cylindrical portion 112_1 toward the opening. A thickness of the first cylindrical portion 112_1 and a thickness of the second cylindrical portion 112_2 may be different from each other, and an elastic member 150 may be disposed on at least a portion of an inner circumferential surface of the second cylindrical portion 112_2.

Referring to FIG. 7, the sidewall part 112 may include the beading portion 113 formed by bending the second cylindrical portion 112_2 and the crimping portion 114 formed by bending one end of the second cylindrical portion 112_2, the crimping portion 114 being connected to the beading portion 113. For example, the beading portion 113 may be formed by bending the second cylindrical portion 112_2 above the electrode assembly 120 inserted into the case 110, and the crimping portion 114 may be formed by bending one end of the second cylindrical portion 112_2 above the cap assembly 140.

In some embodiments, when a short circuit occurs between a first electrode and a second electrode of the electrode assembly 120 accommodated in the case 110, a temperature inside the case 110 may rise. When the temperature rises to be equal to or greater than a predetermined temperature, the elastic member 150 may melt. For example, the elastic member 150 interposed between the gasket 145 of the cap assembly 140 and the second cylindrical portion 112_2, which includes the beading portion 113 and the crimping portion 114, may melt. Accordingly, the cap assembly 140 may be easily detached from the case 110, and any flame or gas generated by the short circuit may be discharged through an opening formed at an upper portion of the case 110 due to the detachment of the cap assembly 140. In this manner, a chain explosion to adjacent battery units can be prevented.

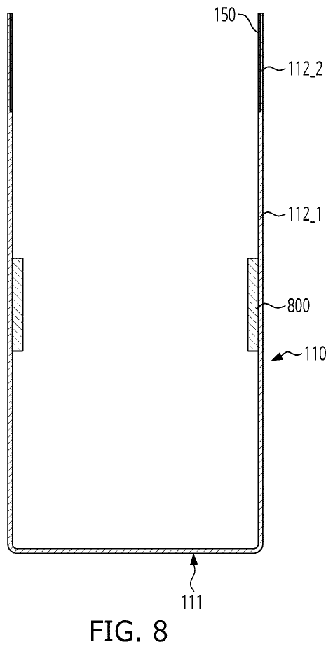

FIG. 8 is a cross-sectional view of a case including a stepped portion. The sidewall part 112 of the case 110 illustrated in FIG. 8 may represent the case 110 in a state before the second cylindrical portion 112_2 is bent to form the beading portion and the crimping portion.

Referring to FIG. 8, the case 110 may include a stepped portion 800 protruding from an inner circumferential surface of the first cylindrical portion 112_1. For example, the stepped portion 800 may protrude in a direction of a central axis of the case 110 from the inner circumferential surface of the first cylindrical portion 112_1. Accordingly, rigidity of the sidewall part 112 of the case 110 may be reinforced.

In some embodiments, the stepped portion 800 may be located at an intermediate portion of the first cylindrical portion 112_1 in a longitudinal direction of the case 110, but the present disclosure is not limited thereto. For example, a position of the stepped portion 800 may be appropriately changed within a range in which rigidity of the sidewall part 112 of the case 110 can be secured. In some embodiments, a thickness of the stepped portion 800 is not limited to that illustrated in FIG. 8. For example, the thickness of the stepped portion 800 may be appropriately changed within a range in which rigidity of the sidewall part 112 of the case 110 can be secured.

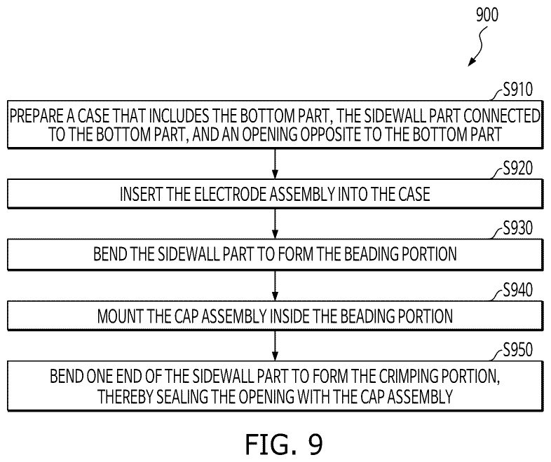

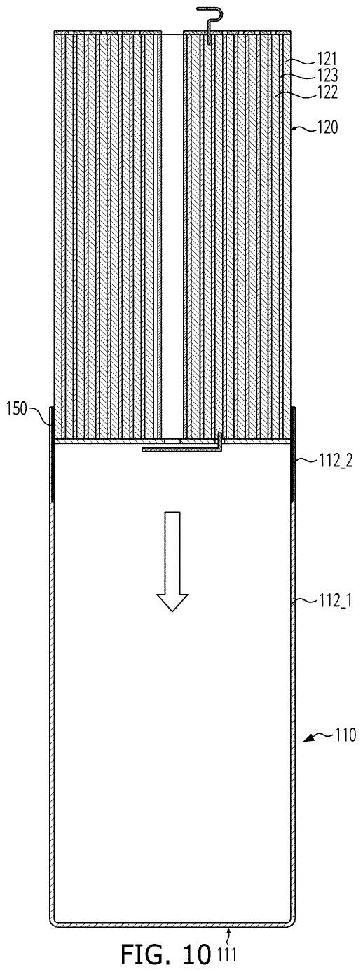

FIG. 9 is a flowchart of a method of manufacturing a secondary battery. FIGS. 10 to 12 shows the method of manufacturing a secondary battery.

A method 900 of manufacturing a secondary battery may include preparing a case 110 which includes the bottom part 111, the sidewall part 112 connected to the bottom part 111, and an opening opposite to the bottom part 111 (S910). In some embodiments, the sidewall part 112 may include the first cylindrical portion 112_1 extending from the bottom part 111 and the second cylindrical portion 112_2 extending from the first cylindrical portion 112_1 toward the opening. A thickness of the first cylindrical portion 112_1 and a thickness of the second cylindrical portion 112_2 may be different from each other, and an elastic member 150 may be disposed on at least a portion of an inner circumferential surface of the second cylindrical portion 112_2. The thickness of the first cylindrical portion 112_1 may correspond to a thickness obtained by adding a thickness of the elastic member 150 to the thickness of the second cylindrical portion 112_2, and the thickness of the second cylindrical portion 112_2 may correspond to the thickness of the elastic member 150.

The electrode assembly 120 may be inserted into the case 110 (S920). Because the elastic member 150 is disposed on at least a portion of the inner circumferential surface of the second cylindrical portion 112_2, a collision between the electrode assembly 120 and the case 110, that may occur while the electrode assembly 120 is inserted into the case 110, may be mitigated. For example, when a central axis of the electrode assembly 120 and a central axis of the case 110 are not aligned while the electrode assembly 120 is inserted into the case 110, an impact generated at a contact portion, where the electrode assembly 120 collides with one end of the second cylindrical portion 112_2, may be mitigated. FIG. 10 is a cross-sectional view illustrating the inserting the electrode assembly 120 into the case 110 in step S920.

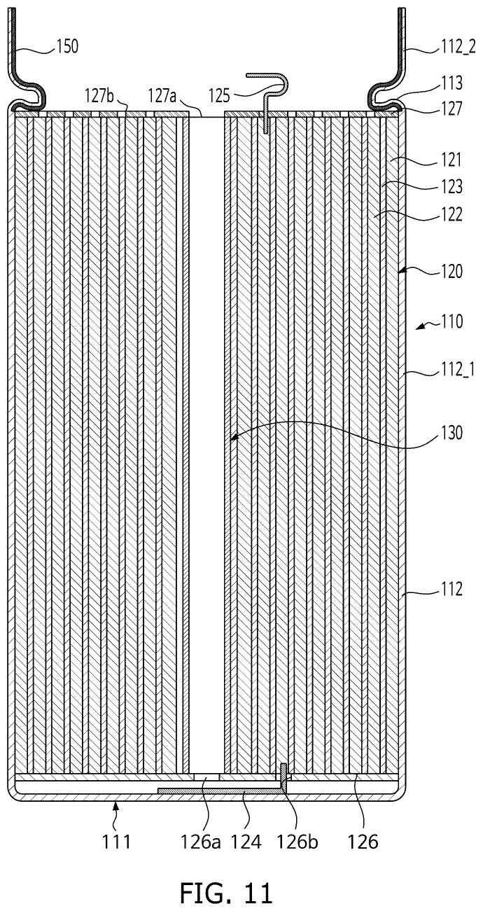

The sidewall part 112 may be bent to form the beading portion 113 (S930). Forming the beading portion 113 (S930) may include bending the second cylindrical portion 112_2 on which the elastic member 150 is disposed. The beading portion 113 may suppress movement of the electrode assembly 120 inside the case 110 and may facilitate seating of the cap assembly 140. In some embodiments, the elastic member 150 may be disposed on one surface of the beading portion 113. FIG. 11 is a cross-sectional view illustrating the bending the sidewall part 112 to form the beading portion 113 in step S930.

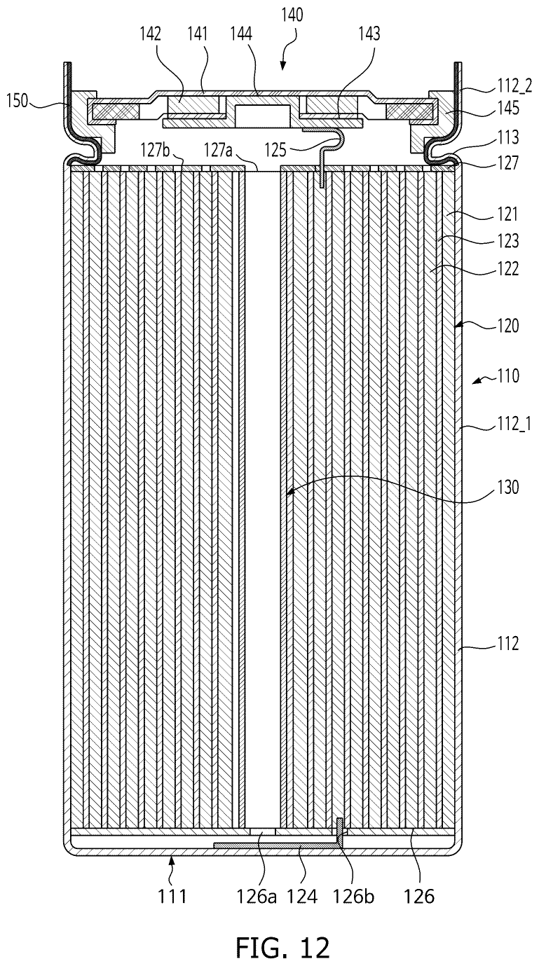

The cap assembly 140 may be mounted inside the beading portion 113 (S940). The cap assembly 140 may be seated on the case 110 by the beading portion 113. Specifically, the cap assembly 140 may be seated on the case 110 by contacting the beading portion 113 on which the elastic member 150 is disposed through a gasket 145. FIG. 12 is a cross-sectional view illustrating the mounting the cap assembly 140 inside the beading portion 113 in step S940.

Referring to FIG. 2, one end of the sidewall part 112 may be bent to form the crimping portion 114, thereby sealing the opening with the cap assembly 140 (S950). Sealing the opening (S950) may include bending one end of the second cylindrical portion 112_2 on which the elastic member 150 is disposed. The crimping portion 114 may firmly fix the cap assembly 140 by pressing an edge of the cap assembly 140 through the gasket 145.

Although the present disclosure has been described above with respect to embodiments thereof, the present disclosure is not limited thereto. Various modifications and variations can be made thereto by those skilled in the art within the spirit of the present disclosure.

### DESCRIPTION OF SELECT REFERENCE COMPONENTS

100: secondary battery
110: case
111: bottom part
112: sidewall part
112_1: first cylindrical portion
112_2: second cylindrical portion
113: beading portion
114: crimping portion
120: electrode assembly
130: center pin
140: cap assembly
150: elastic member
800: stepped portion

What is claimed is:

1. A case for a secondary battery, the case comprising:
a bottom part; and
a sidewall part connected to the bottom part, the bottom part and the sidewall part defining an opening opposite to the bottom part,
wherein the sidewall part comprises a first cylindrical portion extending from the bottom part and a second cylindrical portion extending from the first cylindrical portion toward the opening,
wherein a thickness of the first cylindrical portion and a thickness of the second cylindrical portion are different, and
wherein an elastic member is disposed on at least a portion of an inner circumferential surface of the second cylindrical portion.

2. The case according to claim 1, wherein the thickness of the first cylindrical portion is substantially equal to a sum of a thickness of the elastic member and the thickness of the second cylindrical portion.

3. The case according to claim 2, wherein the thickness of the second cylindrical portion is substantially equal to the thickness of the elastic member.

4. The case according to claim 1, wherein the elastic member extends along the inner circumferential surface from one end of the second cylindrical portion.

5. The case according to claim 1, further comprising a stepped portion protruding from an inner circumferential surface of the first cylindrical portion.

6. The case according to claim 1, wherein the second cylindrical portion is bent inward forming a beading portion.

7. The case according to claim 6, wherein one end of the second cylindrical portion is bent inward forming a crimping portion.

8. The case according to claim 1, wherein the elastic member is configured to melt upon a temperature inside the case being equal to or greater than a predetermined temperature.

9. A secondary battery comprising:
an electrode assembly;
a case comprising a bottom part and a sidewall part connected to the bottom part, the bottom part and the sidewall part defining an opening opposite to the bottom part, the case accommodating the electrode assembly; and
a cap assembly coupled to one end of the sidewall part, the cap assembly configured to seal the opening,
wherein the sidewall part comprises a first cylindrical portion extending from the bottom part and a second cylindrical portion extending from the first cylindrical portion toward the opening,
wherein a thickness of the first cylindrical portion and a thickness of the second cylindrical portion are different, and
wherein an elastic member is disposed on at least a portion of an inner circumferential surface of the second cylindrical portion.

10. The secondary battery according to claim 9, wherein the thickness of the first cylindrical portion is substantially equal to a sum of a thickness of the elastic member and the thickness of the second cylindrical portion.

11. The secondary battery according to claim 10, wherein the thickness of the second cylindrical portion is substantially equal to the thickness of the elastic member.

12. The secondary battery according to claim 9, wherein the elastic member extends along the inner circumferential surface from one end of the second cylindrical portion.

13. The secondary battery according to claim 9, wherein the case further comprises a stepped portion protruding from an inner circumferential surface of the first cylindrical portion.

14. The secondary battery according to claim 9, wherein the second cylindrical portion is bent inward forming a beading portion.

15. The secondary battery according to claim 14, wherein one end of the second cylindrical portion is bent inward forming a crimping portion.

16. The secondary battery according to claim 9, wherein the elastic member is configured to melt upon a temperature inside the case being equal to or greater than a predetermined temperature.

17. A method of manufacturing a secondary battery comprising:
preparing a case comprising a bottom part and a sidewall part connected to the bottom part, the bottom part and the sidewall part defining an opening opposite to the bottom part;
inserting an electrode assembly into the case;
forming a beading portion by bending the sidewall part;
mounting a cap assembly inside the beading portion; and
forming a crimping portion by bending one end of the sidewall part, thereby sealing the opening with the cap assembly,
wherein the sidewall part comprises a first cylindrical portion extending from the bottom part and a second cylindrical portion extending from the first cylindrical portion toward the opening,
wherein a thickness of the first cylindrical portion and a thickness of the second cylindrical portion are different, and
wherein an elastic member is disposed on at least a portion of an inner circumferential surface of the second cylindrical portion.

18. The method according to claim 17, wherein the forming the beading portion comprises bending the second cylindrical portion on which the elastic member is disposed.

19. The method according to claim 17, wherein the forming the crimping portion comprises bending one end of the second cylindrical portion on which the elastic member is disposed.

20. The method according to claim 17, wherein the thickness of the first cylindrical portion is substantially equal to a sum of a thickness of the elastic member and the thickness of the second cylindrical portion.
